(19) United States
(12) Patent Application Publication
(10) Pub. No.: US 2024/0409419 A1
(43) Pub. Date: Dec. 12, 2024

(54) APPLICATION OF PERFORMIC ACID (PFA) FOR MINERAL PROCESSING

(71) Applicant: KEMIRA OYJ, Helsinki (FI)

(72) Inventors: Forrest STRICKLAND, LaGrange, GA (US); Iris PORAT, Mableton, GA (US); Miguel PELAEZ, Decatur, GA (US); Chris HILL, Atlanta, GA (US)

(21) Appl. No.: 18/700,743

(22) PCT Filed: Oct. 13, 2022
(86) PCT No.: PCT/US2022/078008

§ 371 Date: Apr. 12, 2024

Related U.S. Application Data
(60) Provisional application No. 63/255,198, filed on Oct. 13, 2021.

(51) Int. Cl. C01B 33/40

(52) U.S. Cl. CPC C01B 33/40

(57) ABSTRACT

A method for oxidative brightening and whitening of a mined mineral is provided. The mined mineral to be brightened may be discolored kaolin clay, such as gray clay. The inventive method comprises adding to an aqueous slurry of a mined mineral to be brightened an oxidizing solution comprising a peroxyacid, such as performic acid and recovering bleached mineral of improved brightness, color and/or improved purity compared to the mineral to be brightened.

### RELATED APPLICATIONS

This application claims priority to provisional U.S. Application No. 63/255,198, the contents of which are incorporated by reference in their entirety.

### FIELD OF THE INVENTION

The present invention generally relates to a method for increasing the brightness and/or whiteness of mined minerals such as kaolin clay of the type that is capable of being bleached by an oxidative reagent. More specifically, the invention relates to brightening such clay in the form of an aqueous slurry with a peroxyacid, which is capable of producing hydroxyl radical in solution.

### BACKGROUND OF THE INVENTION

The commercial value of numerous mined minerals, such as kaolin clays which are frequently used as pigments and fillers, is directly related to the brightness and whiteness of the mineral. Of this set of mined minerals, those that are discolored or those having lower standard brightness (GE brightness) are less commercially valuable than those with greater brightness and whiteness.

Kaolin is most commonly used in the paper-coating industry. It is also used as a filler (added to plastics, for example, and rubber compounds), as a pigment additive in paints, in ceramics (tile, chinaware, and bathroom toilets and sinks), and in pharmaceuticals. A very white, bright product is required for this use.

Most mined minerals are discolored, some to a degree where no process can sufficiently improve their brightness, others to a degree where improvement in brightness and whiteness can be obtained by beneficiating techniques, thus increasing their value as pigment and filler materials. Small increases in the brightness of kaolin products (e.g., brightness increases of as little as 0.5 on the GE scale) may have an appreciable effect on the commercial value of the product.

Discoloration of mined minerals may occur due to the presence of gangue minerals, metal oxides, and organic impurities in the matrix of the mined ore. In the early days of kaolin mining, gray kaolin clays could not be utilized for commercial applications because there were no methods of removing the staining without destroying the crystalline structure of the particles. The staining was believed to be caused by organic matter settled into the kaolin and subsequently decaying to impart the grey discoloration. Other primary sources of color in kaolin clays include hydrated iron oxides, ilmenite, substituted iron, tourmaline, and micas. Bleaching and/or removal of these discolored impurities is essential for enhancing the brightness, whiteness and overall purity of crude or partially purified mined minerals.

Physical beneficiation techniques such as gravity separation, flotation, and magnetic separation are solid-solid separation techniques that can improve the purity of discolored mined minerals; however, these techniques are often not sufficient for minerals that require a high degree of whiteness and/or brightness. Beneficiation techniques which employ polymeric chemical additives such as selective flocculation and selective separation may be necessary to remove additional discolored impurities.

The kaolin processing industry has historically used natural and synthetic polymers to separate discolored kaolin from naturally bright kaolin. Selective flocculation is a process in which polymeric additives selectively agglomerate the bright clay particles, allowing for their isolation by filtration or other solid-liquid separation technique. Selective separation is a process in which discolored clay particles are flocculated and isolated by solid-liquid separation techniques. For both processes, separation may also be achieved using conventional thickening devices such as thickeners, centrifuges, or other solid/liquid separation devices. These techniques allow the brightness and whiteness of the product to be considerably improved; however, such techniques require the addition of polymeric flocculants, which are difficult to completely remove and may cause downstream issues with the final mined mineral product. Residual polymer will remain in the kaolin, so it must be removed to limit downstream impacts on the kaolin quality.

For many decades the kaolin clay industry has been bleaching kaolin clays with reducing bleaches such as hydrosulfite (dithionite) salts to provide clay products of increased brightness and value. Not all kaolin clays, however, respond adequately to reductive bleaching. Gray kaolin in particular does not respond satisfactorily, if at all, to the action of reducing bleaches absent pretreatment. Another notable disadvantage of reductive bleaching with dithionite is its instability in acidic solutions typical of clay process streams.

Consequently, for many years vast reserves of potentially premium grades of kaolin were of limited use. Widespread utilization of these clays awaited the landmark discovery that oxidative brightening prior to reductive bleaching resulted in a significant improvement in brightness of this type of clay. This discovery is set forth in U.S. Pat. No. 3,353,668, which details the use of oxidative reagents including potassium permanganate (preferred), oxygen gas, alkali bichromates, alkali chlorates, alkali chlorites, ammonium persulfate and soluble peroxides such as sodium and hydrogen peroxide. The use of sodium hypochlorite as an oxidative bleach, such as proposed in U.S. Pat. No. 3,353,356, eventually became widespread in the kaolin industry. U.S. Pat. No. 3,551,515 relates to a method for brightening kaolin clays by oxidation of the organics and simultaneous settling of contaminants and coarse clay particles. Sodium hypochlorite is among the oxidants disclosed. Numerous other patents disclose the use of sodium hypochlorite in bleaching clays. It has been observed that the result of the bleaching of kaolin further improves if after an oxidative bleaching there is carried out a reductive bleaching with sodium dithionite. A process of this type is also disclosed in U.S. Pat. No. 4,935,391.

Another seminal development in the bleaching of gray kaolin resulted from the discovery that ozone gas was an effective oxidative bleach for aqueous slurries of gray kaolin. This discovery was of considerable commercial importance because slurries of gray clay could now be effectively bleached on a commercial scale without leaving noxious by-products originating from other oxidants, such as permanganate and hypochlorite. Another advantage was that ozone did not adversely affect the rheology (viscosity) of the bleached clay product (see U.S. Pat. No. 3,616,900).

Considerable effort by the kaolin industry has been devoted to utilizing ozone in various manners to bleach gray kaolin. In U.S. Pat. No. 3,861,934 the concept of pre-oxidizing kaolin with ozone before applying a reduction bleach was expanded to brightening kaolin clays contaminated with residues of flotation reagents. Use of ozone to bleach floated and unfloated grades of kaolin is also disclosed in U.S. Pat. No. 3,635,744. In U.S. Pat. No. 3,674,558 bleaching of clay with ozone is carried out while the clay is dry or substantially dry. U.S. Pat. No. 3,655,038 is directed to an improvement in a process for increasing the brightness of kaolin clay by subjecting pulp of the clay to an oxidation treatment with ozone followed by froth flotation to remove colored impurities. U.S. Pat. No. 4,935,391 teaches the use of hydrogen peroxide prior to or simultaneously with ozone. Australian patent application AU-A-70277/96 discloses for kaolin a purification and bleaching process wherein oxidative ozone is used for bleaching kaolin from organic coloring impurities. In many of the above, use of ozone bleach is preferably followed by a reduction bleach.

Oftentimes for the most challenging applications, ozone is generated on site in a mineral production plant using oxygen as a raw material. Ozone may be used to degrade residual natural or synthetic polymers and other organic contaminants that could cause adverse impact to the final mineral being produced. Ozone has been used for oxidative bleaching because its higher redox potential allows for acceptable results in the brightening process. Traditional oxidizers, such as hydrogen peroxide or chlorine based products, are either not strong enough to have high efficacy or result in downstream issues with the final product.

Lately, the availability of oxygen for industrial uses, like generation of ozone has been limited due to the demand of oxygen for treating Covid-19 patients. With Covid-19 hospitalizations increasing, the amount of oxygen available for industrial applications is being further restricted.

It is accordingly a purpose of this invention to provide an oxidative process for brightening and whitening of kaolin clays on an industrial scale that does not employ ozone or other traditional oxidizers, while retaining the aforementioned advantages of ozone.

It is an additional purpose of the present application is to provide an oxidative brightening method which is effective on numerous mined minerals to be brightened, such as bentonite, gypsum, and multiple discolored clays including gray, white, pink, cream, and the like.

It is an additional purpose of this invention to provide chemical means for effectuating oxidative bleaching of kaolin clay while maintaining a dispersed slurry of adequate concentration that remains fluid during processing and not introducing material that will adversely affect the rheology (i.e., viscosity) of the slurry or the leave a noxious residue in the finished clay product.

This present application discloses a method for employing peroxyacids, such as performic acid in place of ozone for oxidative brightening of mined minerals such as kaolin. In this invention, performic acid (PFA) is used as an oxidant for removing residual polymer and for increasing brightness of the mined mineral by oxidizing gray clay. The inventive method may be used in place of or in combination with reduced amounts of ozone. The present invention satisfies an urgent need of the mining and mineral processing industry.

### SUMMARY OF THE INVENTION

The present disclosure generally encompasses a method for oxidative brightening of mined minerals such as kaolin clay. This method may comprise adding to an aqueous slurry of kaolin clay to be brightened an oxidizing solution comprising a peroxyacid such as performic acid.

In particular, the results disclosed herein demonstrate that a peroxyacid such as performic acid can be used for oxidative brightening of kaolin clays to produce clays with brightness equivalent to or greater than industry standard treatment with ozone.

The subject methods for enhancing the brightness mined minerals may be used as a replacement for or in combination with ozone to afford the following advantages when effected:
(1) the added peroxyacid is a liquid, which may be stored, transported, and added as an aqueous solution as opposed to ozone, which requires an oxygen supply and gas handling equipment,
(2) the inventive method allows for removal of discolored gangue metals, gangue minerals, and residual organic impurities from the discolored crude mineral to be brightened,
(3) the inventive method allows for recovering a bleached mineral of enhanced brightness and/or improved color compared to the discolored crude mineral to be brightened
(4) the inventive method allows for recovering a bleached mineral of improved purity compared to the discolored crude mineral to be brightened.

The present disclosure also generally encompasses a method for oxidative brightening of a mined mineral. This method may comprise adding to an aqueous slurry of a mined mineral to be brightened an oxidizing solution comprising a peroxyacid.

In some embodiments, the mined mineral to be brightened may be selected from the group comprising kaolin, gypsum, talc, and bentonite. In some embodiments, the peroxyacid may be selected from the group consisting of performic acid, peracetic acid, perpropionic acid, peroxymonosulfuric acid (Caro's acid), peroxydisulfuric acid (Marshall's acid), peroxymonophosphoric acid, peroxydiphosphoric acid, or a combination thereof.

In some embodiments, the method may further comprise:
a) optionally adding to said aqueous slurry of a mined mineral to be brightened a bleach-effective quantity of ozone;
b) after said oxidative brightening step is completed, subjecting the resulting brightened aqueous slurry of a mined mineral to reductive bleaching with a reducing agent, such as sodium dithionite; and
c) recovering a bleached mineral of increased brightness, improved color, and/or improved purity compared to said mined mineral to be brightened.

The invention also provides a bleached mineral obtainable by a method according to any of the foregoing.

The present disclosure also generally encompasses a method for treating a discolored mined mineral. This method may comprise:
a) combining a carboxylic acid, hydrogen peroxide, an acid catalyst, and water in a chemical mixer to form an oxidative bleach solution and allowing said oxidative bleach solution to reach equilibrium;
b) allowing the components of said oxidative bleach solution to react until the total amount of peroxyacid in solution is from 8 to 15% by weight;
c) adding the output of said chemical mixer to an aqueous slurry comprising a discolored mined mineral to be brightened and agitating to form a thoroughly incorporated mixture;
d) allowing said thoroughly incorporated mixture to react for 10-90 minutes, or from 30 to 60 minutes in an oxidative brightening step;
e) subjecting the resulting slurry to reductive bleaching with a reducing agent, such as sodium dithionite; and
f) recovering a bleached mineral of enhanced brightness, improved color, and/or improved purity compared to said discolored mined mineral to be brightened.

In some exemplary embodiments of the present method, the carboxylic acid may be selected from the group consisting of formic acid, acetic acid, and propionic acid; the catalyst may be selected from sulfuric acid, hydrochloric acid, or a combination thereof; and the discolored mined mineral may be selected from the group comprising kaolin, gypsum, talc, and bentonite.

The invention also provides a bleached mineral obtainable by a method according to any of the foregoing.

The present disclosure also generally encompasses a method for oxidative brightening of kaolin clay. This method may comprise adding to an aqueous slurry of kaolin clay to be brightened an oxidizing equilibrium solution comprising performic acid.

In some embodiments, the kaolin clay to be brightened may be the result of a mining process. In some embodiments, the discolored kaolin clay to be brightened may be gray clay. In some embodiments, the discolored kaolin clay to be brightened may be discolored non-gray clay. In some exemplary embodiments, the aqueous slurry of kaolin clay to be brightened may comprise residual organic polymers, discolored gangue minerals, and/or discolored metals.

In some exemplary embodiments, the particle size of kaolin clay in said aqueous slurry of kaolin clay to be brightened may range from about 0.2 to 40 μm.

In some embodiments, the concentration of kaolin clay in said aqueous slurry of kaolin clay to be brightened may range from about 10 to 70% by weight.

In some embodiments, the total dry matter content in said aqueous slurry of kaolin clay to be brightened may range from about 10 to 80% by weight.

In some embodiments, the oxidizing equilibrium solution comprising performic acid is an aqueous equilibrium solution may be prepared by reaction of formic acid and hydrogen peroxide in the presence of an acid catalyst and optionally a stabilizer.

In some embodiments, formic acid and hydrogen peroxide may be combined in a molar ratio of formic acid to hydrogen peroxide ranging from 1:10 to 10:1, preferably from 1:2 to 2:1, more preferably at a ratio of 1:1.

In some embodiments, the catalyst may comprise at least one mineral acid selected from the group comprising sulfuric acid, hydrochloric acid, and a mixture of sulfuric and hydrochloric acids.

In some embodiments, the optional stabilizer may be selected from the group comprising a phosphonate such as 1-hydroxyethylene-1,1-diphosphonic acid, or a pyridinecarboxylic acid such as dipicolinic acid, and a mixture thereof.

In some embodiments, formic acid, hydrogen peroxide, acid catalyst, and the optional stabilizer may be thoroughly combined in water until an oxidizing equilibrium solution is formed comprising at least formic acid, hydrogen peroxide, and performic acid.

In some embodiments, the total amount of performic acid in said oxidizing equilibrium solution is from 8 to 15% by weight.

In some embodiments, the molar ratio of performic acid and formic acid to hydrogen peroxide in said oxidizing equilibrium solution may range from 1:1 to 3.5:1, preferably from 1.5:1 to 3:1.

In some embodiments, the oxidizing equilibrium solution comprising performic acid may be continuously prepared in situ in a chemical mixer and may be added directly to said aqueous slurry of kaolin clay as an equilibrium solution within a time period ranging from 0.1-2 hours after mixing

In other embodiments, the oxidizing equilibrium solution comprising performic acid may be prepared on site or off site as a stabilized equilibrium solution and may be added to said aqueous slurry of kaolin clay after storage for a time period.

In some embodiments, the oxidizing equilibrium solution comprising performic acid may be added to said aqueous slurry comprising kaolin clay and the resulting slurry may be agitated to form a thoroughly incorporated mixture.

In some embodiments, the total performic acid in said thoroughly incorporated mixture may range from 10 ppm to 3000 ppm, wherein ppm is defined as wet weight of performic acid (e.g., milligrams of performic acid indicated as a 100% performic acid) to dry weight of kaolin clay (e.g., kilogram of dry kaolin clay).

In some embodiments, the pH of said thoroughly incorporated mixture may range from 2.0 to 8.5, or from 3.0 to 7.0.

In some embodiments, the contact time between performic acid and kaolin clay to be brightened in said thoroughly incorporated mixture may range from 10 min to 90 min, or from 30 to 60 minutes.

In some embodiments, the oxidative brightening may effected during beneficiation of an aqueous slurry of kaolin clay to be brightened.

In some embodiments, the inventive method may comprise:
a) optionally subjecting said aqueous slurry of kaolin clay to be brightened to a bleach-effective quantity of ozone;
b) subjecting said aqueous slurry of kaolin clay to be brightened to one or more additional beneficiation steps selected from the group comprising selective flocculation, selective solid/solid separation, magnetic separation, media grinding, flotation, centrifugation, thickening, and combinations thereof, wherein said additional beneficiation steps may be effected prior to or after said oxidative brightening step is completed;
c) subjecting said aqueous slurry of kaolin clay to be brightened to reductive bleaching with a reducing agent selected from the group comprising dithionite, bisulfite, borohydride, aluminum hydride, and salts thereof, wherein said reductive bleaching step may be effected after said oxidative brightening and said additional beneficiation steps are completed;
d) acidification of said aqueous slurry of kaolin clay to a pH ranging from 2.5 to 4.5, dewatering, and drying, wherein said acidification, dewatering, and drying steps may be effected after the step of reductive bleaching is completed; and
e) recovering bleached kaolin clay of increased brightness, improved color, and/or improved purity compared to the kaolin clay to be brightened.

In some embodiments, the method of oxidative brightening may result in (i) degradation and removal of residual organic polymers, (ii) removal of discolored gangue minerals, and/or (iii) removal of discolored metals from the kaolin clay to be brightened.

The invention also provides a bleached kaolin clay obtainable by a method according to any of the foregoing.

The invention also provides compositions comprising an aqueous slurry of a mineral, such as kaolin clay, optionally the result of a mining process, and an amount of an oxidizing solution comprising performic acid effective to brighten the kaolin clay.

### BRIEF DESCRIPTION OF THE DRAWINGS

The invention will be described in more detail with reference to appended drawings, described in detail below.

FIG. 1 provides an exemplary process flow diagram depicting one of many possible combinations of multiple methods for mining and purification of kaolin clays according to Example 1.

### DETAILED DESCRIPTION OF THE INVENTION

Before describing the invention, the following definitions are provided. Unless stated otherwise all terms are to be construed as they would be by a person skilled in the art.

### Definitions

As used herein, the singular forms “a”, “and”, and “the” include plural referents unless the context clearly dictates otherwise. All technical and scientific terms used herein have the same meaning as commonly understood to one of ordinary skill in the art to which this invention belongs unless clearly indicated otherwise.

The term “peroxy acid” or “peroxyacid” refers to any compound which contains an acidic —OOH group and generally dissociates to liberate a reactive hydroxyl radical in solution. Non-limiting examples of peroxyacids include performic acid, peracetic acid, perpropionic acid, peroxymonosulfuric acid (Caro's acid), peroxydisulfuric acid (Marshall's acid), peroxynitric acid, monoperoxyphthalic acid, chloroperoxybenzoic acid and peroxydiphosphoric acid.

The term “process stream” generally refers to any aqueous fluids or slurries produced during any type of industrial process, for example, a mineral mining process, mineral processing, mineral purification, mineral beneficiation and/or wet processing, a mineral recovery process, a waste treatment process, or any portion thereof. An exemplary process stream includes an aqueous slurry of a mined mineral, such as kaolin clay, from any phase of the mineral mining process including recovery, transport, beneficiation, wet processing, dewatering, or waste treatment.

The term “mined mineral” generally refers to the product of any mining or mineral processing operation. The mined mineral may be from any stage of the mineral purification process including, a raw crude mineral, a partially purified mineral, a purified mineral. Exemplary mined minerals include but are not limited to the products of clay mining, coal mining, copper mining, gold mining, and mineral processing, such as, for example, processing of phosphate, diamond, gold, mineral sands, zinc, lead, copper, silver, uranium, nickel, iron ore, coal, oil sands, and/or red mud. Exampled of mined minerals may include oxides of aluminum, oxides of silicon, oxides of titanium, kaolin clay, gypsum, talc, bentonite, gray clay, non-gray clay, or any mineral used as a pigment for paints, coatings, paper or board, pharmaceutical formulation, or any other industrial process that requires minerals with predetermined brightness or whiteness characteristics. While many of the embodiments are described with reference to kaolin clays, it is understood that the embodiments, including compositions, processes, and methods, are not limited to applications involving kaolin clays, but also can be applied to various other mined minerals, pigments, and fillers to be bleached or brightened such as granite, marble, bentonite, talc, and gypsum.

The term “flocculant” may generally refer to a reagent that may bridge neutralized or facilitate coagulation of particles into larger agglomerates, typically resulting in more efficient settling. Flocculation process generally involves addition of a flocculant followed by mixing to facilitate collisions between particles, allowing for the destabilized particles to agglomerate into larger particles that can be removed by gravity through sedimentation or by other means, e.g., centrifugation, filtration.

The term “dewatering” or “solid-liquid separation” herein refers to any industrial process by which a process feed from any type of industrial process, for example, a mineral mining process, a mineral purification process, or any portion thereof comprising liquids and solids is treated to separate water out and produce a solid material or cake with a lower water content than prior to dewatering. Exemplary solid-liquid separation processes for the current application include centrifugation, thickening, filtration, hydrocyclone, inline flocculation, gravity sedimentation, evaporation, spray drying, and/or apron drying.

The terms “ozone feed” or “feed” refers to a process stream from any type of industrial process, for example, a mineral beneficiation process, a mineral purification process, or any portion thereof wherein a solution, dispersion, suspension, or slurry is directed into an ozone unit, which provides for contact between ozone and a material to be oxidatively bleached with ozone. An exemplary feed for the current application includes a slurry of discolored kaolin clay that is fed into an ozone unit for oxidative bleaching.

The term “clay” generally refers to fine-grained geologic material containing clay minerals that develops plasticity when wet, but becomes hard, brittle and non-plastic upon drying or firing. Typical mined clay particles have a particle size of 2-40 micrometers with fine clays having a particle size of less than 2 micrometers which comprise mixtures of fine-grained clay minerals, typically hydrous aluminum silicates with variable amounts of other metals, and clay-sized crystals of other minerals such as quartz, carbonate, and metal oxides. Common clays include illite, kaolinite, bentonite, montmorillonite, talcum, vermiculite, pyrophyllite, and chlorite. Natural clay deposits are mixtures of clay minerals, along with other weathered minerals, metal oxides, and residual organic matter.

The term “kaolin clay” generally refer to clays that are predominantly composed of Kaolin Group (kandite) minerals, e.g., kaolinite, halloysite, dickite, nacre, illite. The most common constituent of kaolin clay is the mineral kaolinite. Kaolinite is a layered silicate made of alternating sheets of octahedrally coordinated aluminum and tetrahedrally coordinated silicon that are bonded by hydroxyl groups. Kaolinite is represented by the chemical formula Al₂Si₂O₅(OH)₄, and it most often occurs as clay-sized, platelike, hexagonally shaped crystals. Within eastern North America, kaolin deposits are of three types: (1) “soft” kaolin, which breaks easily and is soapy in texture; (2) “hard” kaolin, which is more finely grained, difficult to break, and jagged in texture; and (3) “flint” kaolin, which has high opaline silica content and is extremely hard. Kaolin particles are mainly in the size range of 25-35 μm, with few particles having a smaller size distribution, the smallest of which vary between 0.4-0.75 μm. Kaolin is most commonly used in the paper-coating industry. It is also used as a filler (added to plastics, for example, and rubber compounds), as a pigment additive in paints, in ceramics (tile, chinaware, and bathroom toilets and sinks), and in pharmaceuticals. Depending upon the application, kaolin clays are typically processed to remove such naturally coexisting materials as quartz, iron oxides, titanium oxides, other clay minerals, and organic matter. Kaolin is often further modified from its natural state by chemical treatments, physical delaminating, and high temperature heating to more than 1,000 degrees centigrade. These latter modifications are designed to enhance chemical bonding properties of the kaolin when mixed with other components and/or to improve the brightness of kaolin-based products.

The term “gypsum” generally refers to a soft sulfate mineral composed of calcium sulfate dihydrate, with the chemical formula CaSO₄·2H₂O, that is widely mined and used as a fertilizer and as the main constituent in many forms of plaster, blackboard chalk, sidewalk chalk, and drywall.

The term “beneficiation” generally refers to improving the whiteness, brightness, and/or purity of a mined mineral by removing discoloring impurities or impurities that may be harmful to the production process such as gangue minerals, gangue metals such as iron, titanium and other organic matter, or to improve the quality of kaolin by removing sandy minerals such as quartz and feldspar. The kaolin purification processes currently used mainly include gravity separation, magnetic separation, flotation, reductive leaching/bleaching, chemical bleaching, selective flocculation, selective separation,

As used herein, the term “wet processing” generally refers to purification or beneficiation of a mined mineral in the form of an aqueous suspension or slurry.

The term “reductive bleaching” or “reductive leaching” generally refers to addition of a reducing agent, such as sodium dithionite, which reduces and solubilizes discolored gangue minerals, such as iron oxides, for removal from a process stream by filtration or other solid-liquid separation method.

The term “solid-solid separation” generally refers to the separation of particulate solids of a specific type from a mixture of particulate solids comprising multiple types.

The term “selective flocculation” refers to preferential adsorption of an organic flocculant, typically a polymeric additive such as polyacrylamide or acrylamide copolymers, on the desired mineral solids to be flocculated from a mixed suspension, leaving the remainder of the particles in suspension. Selective flocculation utilizes the differences in the physical-chemical properties of the various mineral and gangue components in the mixed suspension. The desired mineral components are selectively flocculated and isolated by filtration or other solid-liquid separation technique.

As used herein, the term “selective separation” refers to preferential adsorption of an organic flocculant, typically a polymeric additive, on the unwanted solids to be flocculated (e.g., discolored minerals or metal oxides) from a mixed suspension, leaving the remainder of the desired particles in suspension. The unwanted solids may be removed by filtration or other solid-liquid separation technique.

The term “magnetic separation” generally refers to the process of removing weakly magnetic dyeing impurities such as hematite, siderite, pyrite and rutile from mined minerals such as kaolin.

The terms “gangue” and “gangue components” refer to the commercially valueless “unwanted” material that surrounds, or is closely mixed with, a “desired” mineral, such as kaolin clay in an ore deposit.

The term “equilibrium solution” refers to a solution phase chemical reaction that has reached equilibrium, wherein the rate of formation of products is equal to the rate of formation of starting materials.

As used herein, the term “bleaching” refers generally to a process for brightening, whitening and/or removal of discolored impurities from a process stream.

As used herein, the term “oxidative brightening” refers to increasing the brightness of a mined mineral by contacting a mineral to be brightened with an oxidizing agent.

As used herein, the term “ozone equivalent” refers to oxidative bleaching or brightening of a material with an oxidizing agent, such as potassium permanganate, which is used as laboratory scale method of simulating the brightness achievable by treating the same material in a process feed with ozone in a process plant environment. The treatment may be effected at ambient temperature or at an elevated temperature.

The term “gray clay” generally refers to mined clays or partially purified clays containing gray staining due to the presence of gray colored mineral or metal oxide impurities.

As used herein, the term “discolored non-gray clay” refers to mined clays or partially purified clays containing staining due to the presence of non-gray colored (e.g., pink, cream, off-white, etc.) mineral impurities, metal oxide impurities, or residual organic impurities.

As used herein, the terms “residual organic” or “organic impurities” generally refer to polymeric or non-polymeric organic compounds within the mineral matrix. These organic impurities may comprise material from natural environmental sources or may be introduced as chemical additives during mineral mining and processing. An exemplary residual organic impurity comprises residual polymer used for selective flocculation or selective separation, such as polyacrylamide or acrylamide copolymers, which are present after the bulk of flocculated material has been removed and may cause adverse downstream effects.

The term “GE brightness” refers to the quantified percentage of blue light reflected from the surface of a solid material such as a mined mineral, measured at a specific effective wavelength. Brightness does not indicate the color or relative shade of the material. A brighter material reflects a greater amount of blue light than does the surface of a less bright material. GE brightness is an industry standard method measurement for brightness, expressed as the quantity of reflected light received by a photocell based on a scale relative to the amount of light that would be reflected from a 100% reflective magnesium oxide standard.

The term “whiteness” refers to the relative degree to which a material is white.

For the present applicant, the terms “contact time” or “residence time” refer to the amount of time between addition of a reagent (e.g., peroxyacid, ozone, dithionite, etc.) that contacts a mineral to be bleached, brightened, purified, or otherwise processed and removal of said reagent and/or addition of another reagent in a subsequent processing step.

As used herein, the terms “polymer” or “polymeric additives” and similar terms are used in their ordinary sense as understood by one skilled in the art, and thus may be used herein to refer to or describe a large molecule (or group of such molecules) that may comprise recurring units.

Polymers may be formed in various ways, including by polymerizing monomers and/or by chemically modifying one or more recurring units of a precursor polymer. Unless otherwise specified, a polymer may comprise a “homopolymer” that may comprise substantially identical recurring units that may be formed by, for example, polymerizing, a particular monomer. Unless otherwise specified, a polymer may also comprise a “copolymer” that may comprise two or more different recurring units that may be formed by, for example, copolymerizing, two or more different monomers, and/or by chemically modifying one or more recurring units of a precursor polymer. Unless otherwise specified, a polymer or copolymer may also comprise a “terpolymer” which generally refers to a polymer that comprises three or more different recurring units. Any one of the one or more polymers discussed herein may be used in any applicable process, for example, as a flocculant, a selective flocculant for flocculating an impurity, and/or a selective flocculant for selectively separating a desired mineral.

As used herein, the term “aqueous solution” or “solution” generally refers to a mixture of water and a water-soluble solute or solutes which are completely dissolved. The solution may be homogenous. When mixed with excess of water, the cationic emulsion polymer in the polymer product is preferably fully dissolved and the obtained polymer solution is preferably free from discrete polymer particles or granules.

As used herein, the term “aqueous suspension”, “aqueous slurry”, or “slurry” generally refer to a heterogeneous mixture of a fluid that contains insoluble or sparingly soluble solid particles sufficiently large for sedimentation. Suspensions and slurries of the present invention may also comprise some amount of solid particles, often termed colloidal particles, which do not completely settle or take a long time to settle completely.

The terms, “total solids” or “total suspended solids” are used interchangeably herein and generally refer the total amount or weight of suspended solids contained in oil sands or other sands comprising dispersion. “Total solids” or “total suspended solids” generally does not include dissolved solids.

As used herein, the term “ppm” refers to parts per million on the basis of wet mass of chemical additive (e.g., performic acid) in milligrams per dry mass of mined mineral in kilograms in an aqueous suspension or slurry (e.g., mg/kg of PFA to kaolin clay).

As used herein, the terms “lbs/ton” or “lb/ton” denote pounds of dry mass of added material (e.g., additive, solute, and/or particle) per ton of mined mineral (e.g., weight of chemical additive per dry ton of kaolin clay).

### DESCRIPTION OF THE INVENTION

The present invention provides a method for oxidative brightening of mined minerals such as kaolin clays by treating an aqueous slurry of a mined mineral to be brightened with a peroxyacid, such as performic acid, peracetic acid, or the like.

When raw kaolin is mined, it usually has a brightness rating of only about 75-80% relative to the standard magnesium oxide (value of 100). Mined minerals that are discolored or those having lower standard brightness (GE brightness) are less commercially valuable than those with greater brightness and whiteness. Even small increases in the brightness of kaolin products (e.g., brightness increases of as little as 0.5 on the GE scale) may have an appreciable effect on the commercial value of the product. Achieving a GE brightness increase of 1 is very significant and the goal of every step of beneficiation is to raise GE brightness of a mined mineral by a value of 1 or 2, up to final value of 88-91.

In the current invention, it was surprisingly found that oxidative brightening of kaolin clays with performic acid produced brightness values that were equivalent to or greater than ozone. Because of its high oxidative potential, ozone is capable of oxidatively bleaching mined minerals such as gray kaolin to achieve significant enhancements in brightness. Literature values for the standard oxidation potential of ozone range from 2.0 to 2.1 Volts. Literature values for the standard oxidation potential of selected inventive reagents for oxidative brightening of kaolin clays (e.g., performic acid “PFA” and peracetic acid “PAA”) range from 1.39-1.75 Volts depending on pH of solution. Thus, the oxidative potential of peroxyacids such as PFA and PAA are significantly lower than ozone, which renders the brightness results of the present invention surprising. Without being bound to theory, it may be rationalized that the ability of peroxyacids such as PFA and PAA to lower the pH of the mineral slurry may be beneficial for oxidative brightening if kaolin clays because the oxidation potential of peroxyacids tends to increase as the pH of solution decreases.

The present disclosure generally encompasses a method for oxidative brightening of kaolin clay. This method may comprise adding to an aqueous slurry of kaolin clay to be brightened an oxidizing solution comprising a peroxyacid such as performic acid.

Performic acid is traditionally prepared via an equilibrium reaction between formic acid and hydrogen peroxide in the presence of a strong acid catalyst (e.g., sulfuric acid), resulting in an equilibrium solution according to the following reaction:

formic acid+hydrogen peroxide↔−performic acid+water

The above reaction may be generally applied to the formation of any desired peroxyacid by substituting an appropriate organic or mineral acid (e.g., a carboxylic acid, sulfuric acid, phosphoric acid, and the like) in place of formic acid.

Equilibrium solutions of peracetic acid and performic acid have used as a disinfecting agent for example in process water applications, greenhouses, dairy industry and in the post-bleaching of kraft pulps after delignification and peroxide bleaching steps. (see U.S. Pat. No. 9,617,170). Equilibrium solutions of PAA have also been used for the bleaching of a mineral pigment or a synthetic pigment as described in U.S. Pat. No. 6,270,564 and EP0937754.

In WO 94/20424 performic acid is successfully applied in the control of microbial growth in the horticulture. WO 94/20424 describes the preparation of performic acid solutions in situ by reacting formic acid and hydrogen peroxide in a molar ratio of from 1:10 to 10:1, preferably from 1:1 to 1:5.

Peroxyacid solutions are most commonly prepared via an equilibrium reaction of hydrogen peroxide with the appropriate carboxylic acid. In the case of peracetic acid and carboxylic acids having higher molecular weight, an acid catalysis is required in order to reach the equilibrium in an appropriate period of time. Mineral acids, for example sulfuric acid, hydrochloric acid etc. are commonly applied as acid catalysts in such reactions. In the case of formic acid, an additional acid catalyst may not be necessary.

The reactive carboxylic acid may be an aliphatic C2-C18 carboxylic acid including acetic acid, propionic acid, phtalic acid, oxalic acid, malic acid, maleic acid and fumaric acid and mixtures thereof. The resulting peroxyacid may be an aliphatic C2-C18 peroxyacid including acetic acid, propionic acid, phtalic acid, oxalic acid, malic acid, maleic acid and fumaric acid and mixtures thereof.

Mixed peroxyacid solutions may provide further benefit for oxidative brightening of minerals. A mixed peroxyacid solution comprising more than one peroxyacid may be prepared by pre-mixing a first and a second carboxylic acid followed by the addition of a hydrogen peroxide solution. Alternatively, the peroxyacid solution can be prepared by mixing an aqueous solution of the second carboxylic acid, e.g. acetic acid solution, and hydrogen peroxide solution followed by the addition of the first carboxylic acid, i.e. formic acid to the equilibrium mixture. The reaction equilibria are set in 1-2 hour or in a longer period of time, largely depending on the temperature of the reaction mixture. The reaction temperature can be in the limits of 0° C. to 80° C. Preferably, the reaction temperature should be between 0° C. and 50° C. Most preferably, the reaction temperature should be between 0° and 25° C. in order to obtain the best stability of the peroxyacid solution.

The concentrations of the carboxylic acid solutions applied in the formation of the peroxyacid solution can vary from 30% to 100% by weight. Generally, higher concentrations are favorable in order to reach higher final concentrations of the peroxyacids. The concentration of hydrogen peroxide solution used for the formation of peroxy acid solution can be between 10% and 80% by weight. The hydrogen peroxide is introduced into the solution as an aqueous hydrogen peroxide solution, preferably having a concentration of 10% to 55%, more preferably 30% to 55% by weight. Generally, higher concentrations of hydrogen peroxide are favorable in order to reach higher final concentrations of the peroxyacids. However, safety aspects must be taken into consideration in the preparation of concentrated peroxyacid solutions.

The formation of the equilibrium mixtures of peroxyacids can be catalyzed by the addition of strong acids. The strong acids can be organic acids. Preferably, low molecular weight carboxylic acids can be used as reaction catalysts. Most preferably, formic acid can be used as a catalyst.

Alternatively, the formation of the equilibrium mixtures of peroxyacids can be catalyzed by mineral acids. The mineral acids applicable for catalyzing the formation of peroxyacids include sulfuric acid, phosphoric acid, hydrochloric acid, pyrophosphoric acid and polyphosphoric acid and mixtures thereof. Certain strong acid catalysts such as sulfuric acid and phosphoric acid may also be converted to peroxyacids to some extent under these conditions. These additional peroxyacids may provide additional bleaching and brightening effects on a mined mineral to be brightened. One advantage of for example a sulfuric acid catalyst is that it forms a peroxyacid (Caro's acid) to some extent, which provides an additional source of hydroxyl radicals in the bleaching solution.

The amount of the acid catalyst can be from 0.1 to 20% of the weight of the solution. In addition, ion exchange resins in their acidic forms can be used as a catalyst of said reaction.

Additionally, conventional additives may be introduced into the solution. The additives include stabilizers such as phosphonates, e.g. 1-hydroxy ethylene-1,1-diphosphonic acid (HEDPA), and pyridinecarboxylic acids, e.g. dipicolinic acid, chelating agents and radical scavengers. Also mixtures of stabilizers may be employed. The amount of stabilizer(s) may be from 0.01 to 1% by weight, preferably from 0.05 to 0.5% by weight.

In particular, the results disclosed herein demonstrate that a peroxyacid such as performic acid can be used for oxidative brightening of kaolin clays to produce clays with brightness equivalent to or greater than industry standard treatment with ozone.

The subject methods for enhancing the brightness mined minerals may be used as a replacement for or in combination with ozone to afford the following advantages when effected:
(1) removal of discolored gangue metals, gangue minerals, and residual organic impurities from the discolored crude mineral to be brightened,
(2) recovering a bleached mineral of enhanced brightness and/or improved color compared to the discolored crude mineral to be brightened
(3) recovering a bleached mineral of improved purity compared to the discolored crude mineral to be brightened.

The present disclosure also generally encompasses a method for oxidative brightening of a mined mineral. This method may comprise adding to an aqueous slurry of a mined mineral to be brightened an oxidizing solution comprising a peroxyacid.

In some embodiments, the mined mineral to be brightened may be selected from the group comprising kaolin, gypsum, talc, and bentonite. In some embodiments, the peroxyacid may be selected from the group consisting of performic acid, peracetic acid, perpropionic acid, peroxymonosulfuric acid (Caro's acid), peroxydisulfuric acid (Marshall's acid), peroxymonophosphoric acid, peroxydiphosphoric acid, or a combination thereof.

In some embodiments, the method may further comprise:
a) optionally adding to said aqueous slurry of a mined mineral to be brightened a bleach-effective quantity of ozone;
b) after said oxidative brightening step is completed, subjecting the resulting brightened aqueous slurry of a mined mineral to reductive bleaching with a reducing agent, such as sodium dithionite; and
c) recovering a bleached mineral of increased brightness, improved color, and/or improved purity compared to said mined mineral to be brightened.

The invention also provides a bleached mineral obtainable by a method according to any of the foregoing.

The present disclosure also generally encompasses a method for treating a discolored mined mineral. This method may comprise:
a) combining a carboxylic acid, hydrogen peroxide, an acid catalyst, and water in a chemical mixer to form an oxidative bleach solution and allowing said oxidative bleach solution to reach equilibrium;
b) allowing the components of said oxidative bleach solution to react until the total amount of peroxyacid in solution is from 8 to 15% by weight;
c) adding the output of said chemical mixer to an aqueous slurry comprising a discolored mined mineral to be brightened and agitating to form a thoroughly incorporated mixture;
d) allowing said thoroughly incorporated mixture to react for 10-90 minutes, or from 30 to 60 minutes in an oxidative brightening step;
e) subjecting the resulting slurry to reductive bleaching with a reducing agent, such as sodium dithionite; and
f) recovering a bleached mineral of enhanced brightness, improved color, and/or improved purity compared to said discolored mined mineral to be brightened.

In some exemplary embodiments of the present method, the carboxylic acid may be selected from the group consisting of formic acid, acetic acid, and propionic acid; the catalyst may be selected from sulfuric acid, hydrochloric acid, or a combination thereof; and the discolored mined mineral may be selected from the group comprising kaolin, gypsum, talc, and bentonite.

The invention also provides a bleached mineral obtainable by a method according to any of the foregoing.

The present disclosure also generally encompasses a method for oxidative brightening of kaolin clay. This method may comprise adding to an aqueous slurry of kaolin clay to be brightened an oxidizing equilibrium solution comprising performic acid.

In some embodiments, the kaolin clay to be brightened may be the result of a mining process. In some embodiments, the discolored kaolin clay to be brightened may be gray clay. In some embodiments, the discolored kaolin clay to be brightened may be discolored non-gray clay. In some exemplary embodiments, the aqueous slurry of kaolin clay to be brightened may comprise residual organic polymers, discolored gangue minerals, and/or discolored metals.

In some exemplary embodiments, the particle size of kaolin clay in said aqueous slurry of kaolin clay to be brightened may range from about 0.2 to 40 μm.

In some embodiments, the concentration of kaolin clay in said aqueous slurry of kaolin clay to be brightened may range from about 10 to 70% by weight.

In some embodiments, the total dry matter content in said aqueous slurry of kaolin clay to be brightened may range from about 10 to 80% by weight.

In some embodiments, the oxidizing equilibrium solution comprising performic acid is an aqueous equilibrium solution may be prepared by reaction of formic acid and hydrogen peroxide in the presence of an acid catalyst and optionally a stabilizer.

In some embodiments, formic acid and hydrogen peroxide may be combined in a molar ratio of formic acid to hydrogen peroxide ranging from 1:10 to 10:1, preferably from 1:2 to 2:1, more preferably at a ratio of 1:1.

In some embodiments, the catalyst may comprise at least one mineral acid selected from the group comprising sulfuric acid, hydrochloric acid, and a mixture of sulfuric and hydrochloric acids.

In some embodiments, the optional stabilizer may be selected from the group comprising a phosphonate such as 1-hydroxyethylene-1,1-diphosphonic acid, or a pyridinecarboxylic acid such as dipicolinic acid, and a mixture thereof.

In some embodiments, formic acid, hydrogen peroxide, acid catalyst, and the optional stabilizer may be thoroughly combined in water until an oxidizing equilibrium solution is formed comprising at least formic acid, hydrogen peroxide, and performic acid. In some embodiments, the oxidizing solution comprising performic acid may be an aqueous equilibrium solution comprising additional chemicals such as a stabilizer. In some embodiments, the acid catalyst may also react with hydrogen peroxide to form a peroxyacid product to some extent, such as Caro's acid, which may also provide a bleaching and/or brightening effect to aid beneficiation of the mined mineral.

In some embodiments, the total amount of performic acid in said oxidizing equilibrium solution is from 8 to 15% by weight.

In some embodiments, the molar ratio of performic acid and formic acid to hydrogen peroxide in said oxidizing equilibrium solution may range from 1:1 to 3.5:1, preferably from 1.5:1 to 3:1.

In some embodiments, the oxidizing equilibrium solution comprising performic acid may be continuously prepared in situ in a chemical mixer and may be added directly to said aqueous slurry of kaolin clay as an equilibrium solution within a time period ranging from 0.1-2 hours after mixing. In other embodiments the oxidizing equilibrium solution comprising performic acid may be added immediately after mixing.

In other embodiments, the oxidizing equilibrium solution comprising performic acid may be prepared on site or off site as a stabilized equilibrium solution and may be added to said aqueous slurry of kaolin clay after storage for a time period. In some embodiments the storage time may be greater than 2 hours.

In some embodiments, the oxidizing equilibrium solution comprising performic acid may be added to said aqueous slurry comprising kaolin clay and the resulting slurry may be agitated to form a thoroughly incorporated mixture.

In some embodiments, the total performic acid in said thoroughly incorporated mixture may range from 10 ppm to 3000 ppm, wherein ppm is defined as wet weight of performic acid (e.g., milligrams of performic acid indicated as a 100% performic acid) to dry weight of kaolin clay (e.g., kilogram of dry kaolin clay).

In some embodiments, the pH of said thoroughly incorporated mixture may range from 2.0 to 8.5, or from 3.0 to 7.0.

In some embodiments, the contact time between performic acid and kaolin clay to be brightened in said thoroughly incorporated mixture may range from 10 min to 90 min, or from 30 to 60 minutes.

In some embodiments, the oxidative brightening may effected during beneficiation of an aqueous slurry of kaolin clay to be brightened.

In some embodiments, the inventive method may comprise:
a) optionally subjecting said aqueous slurry of kaolin clay to be brightened to a bleach-effective quantity of ozone;
b) subjecting said aqueous slurry of kaolin clay to be brightened to one or more additional beneficiation steps selected from the group comprising selective flocculation, selective solid/solid separation, magnetic separation, media grinding, flotation, centrifugation, thickening, and combinations thereof, wherein said additional beneficiation steps may be effected prior to or after said oxidative brightening step is completed;
c) subjecting said aqueous slurry of kaolin clay to be brightened to reductive bleaching with a reducing agent selected from the group comprising dithionite, bisulfite, borohydride, aluminum hydride, and salts thereof, wherein said reductive bleaching step may be effected after said oxidative brightening and said additional beneficiation steps are completed;
d) acidification of said aqueous slurry of kaolin clay to a pH ranging from 2.5 to 4.5, dewatering, and drying, wherein said acidification, dewatering, and drying steps may be effected after the step of reductive bleaching is completed; and
e) recovering bleached kaolin clay of increased brightness, improved color, and/or improved purity compared to the kaolin clay to be brightened.

In some embodiments, the method of oxidative brightening may result in (i) degradation and removal of residual organic polymers, (ii) removal of discolored gangue minerals, and/or (iii) removal of discolored metals from the kaolin clay to be brightened.

The invention also provides a bleached kaolin clay obtainable by a method according to any of the foregoing.

The invention also provides compositions comprising an aqueous slurry of a mineral, such as kaolin clay, optionally the result of a mining process, and an amount of an oxidizing solution comprising performic acid effective to brighten the kaolin clay.

Having described the invention in detail the invention is further described in the following examples.

### EXAMPLES

The following examples are presented for illustrative purposes only and are not intended to be limiting.

### Example 1: Process Flow Diagram Depicting Mining and Purification of Kaolin Clay

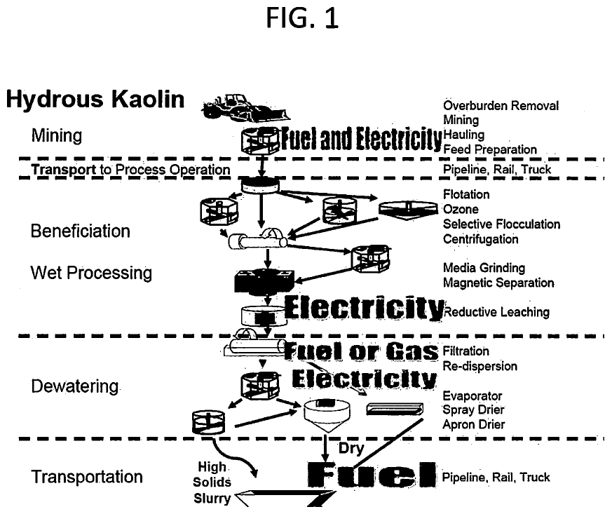

Obtaining high-quality kaolin clay with a single beneficiation process is often difficult, especially for low-grade coal series kaolin and kaolin with complex compositions. In the actual production of kaolin, the combination of multiple beneficiation and wet processes methods is often used. An exemplary process flow diagram depicting one of many possible combinations of multiple methods for mining and processing kaolin clay is shown in FIG. 1.

The exemplary process flow depicts industry standard mining processes for kaolin clay. After transport to the processing plant, the crude mined mineral is subjected to purification by beneficiation and wet processing to improve brightness and remove discolored impurities other gangue components including gangue minerals and organic matter that may be problematic for further processing.

The sequence order of beneficiation and wet processing steps may be changed for every step except reductive bleaching, which for the present invention is effected last. Reductive bleaching involves addition of a reducing agent, such as sodium dithionite, which reduces and solubilizes discolored gangue minerals, such as iron oxides, for removal by filtration. Reductive bleaching is performed under acidic conditions (typically at a pH of 3.0) which flocculates the clay to enable efficient dewatering.

Oxidative brightening of the mined mineral with peroxyacids according to the present invention may be effected at any time during beneficiation and wet processing prior to reductive bleaching.

### Example 2: Determination of the Effects of Oxidative Bleaching with Performic Acid on the Brightness of a First Grey Kaolin Clay

To determine the effectiveness of oxidative brightening of grey kaolin clay with peroxyacids, a five gallon sample of process stream comprising an aqueous slurry of grey clay that was feeding ozone units (“ozone feed” not treated with ozone) was collected. From the same process stream, a one gallon sample of grey clay slurry was collected after treatment with ozone in the same ozone units (“ozone product”).

Samples were transported to a lab for further treatment and analysis. A portion of the untreated ozone feed slurry was used as Control 1. A portion of the ozone feed slurry was dosed with sodium dithionite (also known as sodium hydrosulfite, hereafter “dithionite”) at a dosage of 8 lb/ton (expressed as weight of additive per dry ton of kaolin clay) in an industry standard reductive bleaching step to produce Control 2. A portion of the ozone product sample was treated with dithionite at dosage of 8 lb/ton and used as Control 3. A portion of the ozone feed sample was treated with hot potassium permanganate at dosage of 2 lb/ton in an industry standard “ozone equivalent” bleaching step, which is used as laboratory scale method of simulating the brightness achievable by treating the process feed with ozone from the units. After ozone equivalent bleaching was complete, the sample was treated with dithionite at dosage of 10 lb/ton and used as Control 4.

Portions of the ozone feed were subjected to an oxidative brightening step by treatment with a representative peroxyacid, performic acid (PFA), which was formed on site by reacting formic acid and hydrogen peroxide in the presence of a catalytic amount of sulfuric acid in a chemical mixer to form an equilibrium solution. The equilibrium solution comprising PFA at a concentration of 5-30% by weight was added to the slurry at various concentrations (250 ppm, 500 ppm, 1000 ppm, and 2000 ppm, expressed as wet weight of PFA to dry weight of kaolin clay) for a contact time of one hour followed by acidification with sulfuric acid to a pH of 3 and reductive bleaching with dithionite at a dosage of 10 lb/ton to produce PFA-treated samples.

After treatments were complete, all samples were acidified by addition of sulfuric acid to achieve a pH of about 3. This acidification step flocculates the clay so that it can be filtered to remove water. After most of the water was removed during filtration, the resulting filter cakes were transferred to a microwave oven for final drying. Once the moisture was removed down to <0.1%, the samples were pulverized using a micro grinder, pressed into a pellet, and then analyzed to determine GE Brightness of the resulting clay products. Resulting values for GE brightness are listed in Table 1.

TABLE 1
GE Brightness of Purified Kaolin Samples

| | | Dithionite, | GE |
|---|---|---|---|
| Sample ID | Oxidant, Dosage | lb/ton | Brightness |
| Control 1 (Ozone Feed) | — | — | 86.7 |
| Control 2 (Dithionite Only) | — | 8.0 | 88.8 |
| Control 3 (Ozone Product) | Ozone, 1.5 lb/ton | 8.0 | 88.8 |
| Control 4 (Ozone Equivalent) | KMnO₄, 2 lb/ton | 10.0 | 89.1 |
| PFA-250 | PFA, 250 ppm | 10.0 | 88.7 |
| PFA-500 | PFA, 500 ppm | 10.0 | 88.5 |
| PFA-1000 | PFA, 1000 ppm | 10.0 | 87.0 |
| PFA-2000 | PFA, 2000 ppm | 10.0 | 86.7 |

Results indicate that treatment with PFA at a dosage of 250 ppm produces a clay product of similar brightness as the ozone product (Control 3). As the dosage of PFA was increased, the resulting brightness decreased. Without being bound to theory, it has been rationalized that this trend indicates deactivation of the dithionite reagent by increased levels of PFA above 250 ppm, which suggests lower concentrations of PFA are preferred for oxidative brightening prior to reductive bleaching.

These results provide initial proof of concept that beneficiation of kaolin clay using the inventive method of oxidative brightening/bleaching with PFA achieved brightness equivalent to ozone.

### Example 3: Determination of the Effects of Oxidative Bleaching with Performic Acid on the Brightness of a Second Grey Kaolin Clay

The effectiveness of oxidative brightening of grey kaolin clay with peroxyacids was determined using a process stream comprising a lower quality grade of discolored clay (RGS kaolin clay) which is not typically reductively bleached with dithionite in the processing plant. Kaolin clay slurry samples were collected, treated at dosages indicated in Table 2, and analyzed for GE brightness according to Example 2. Reductive bleaching with dithionite was not performed on these samples. The pH of PFA-treated samples was measured after addition of PFA. Results are shown in Table 2.

TABLE 2
GE Brightness of Purified Kaolin Samples

| Sample ID | Oxidant, Dosage | pH | GE Brightness |
|---|---|---|---|
| Control 1 (Ozone Feed) | — | — | 78.1 |
| Control 2 (Ozone Product) | Ozone, 1.5 lb/ton | — | 78.8 |
| PFA-500 | PFA, 500 ppm | 4.0 | 79.0 |
| PFA-1000 | PFA, 1000 ppm | 3.6 | 79.5 |
| PFA-1500 | PFA, 1500 ppm | 3.4 | 79.0 |
| PFA-2000 | PFA, 2000 ppm | 3.2 | 79.0 |

Results indicate that, in the absence of reductive bleaching, the inventive method of oxidative brightening with PFA produced brightened clay products of higher brightness than the ozone unit alone (for example, comparing GE brightness of 79.5 with 1,000 ppm of PFA to GE brightness of 78.8 after ozone treatment). Without being bound to theory, since there are no readily available methods to determine residual polymer in kaolin matrix, and removal of the grey staining is considered more demanding on the oxidant. Therefore, it stands to reason that PFA would be effective in removing the residual polymer in the slurry.

These results provide further proof of concept that the inventive method of oxidative brightening of mined minerals (e.g., kaolin clay) peroxyacids such as PFA is an effect substitute for oxidative bleaching with ozone. According to the present invention, oxidative bleaching of mined minerals with peroxyacids may be performed in place of or in combination with ozone.

### Example 4: Determination of the Effects of Oxidative Bleaching with Performic Acid on the Brightness of a Third Clay

The effectiveness of oxidative brightening with peroxyacids was determined using a laboratory-prepared clay (LHT clay), which simulates a discolored kaolin clay from a typical process stream. The blended LHT sample was first lab magged (74%@2 μm PSD) and then blended w/DV GWT Cellex O/F at 80/20 ratio to LHT (79.5%@2 μm on blend).

A portion of the blended LHT clay slurry was used as Control 1. A portion of the blended LHT clay slurry was treated with hot potassium permanganate at dosage of 2 lb/ton for 1 h in an industry standard “ozone equivalent” bleaching step at elevated temperature and used as Control 2. A portion of the blended LHT clay slurry was treated with ambient temperature potassium permanganate at dosage of 2 lb/ton in an “ozone equivalent” bleaching step at ambient temperature for 2 h and 24 h and used as Controls 3 and 4, respectively.

Portions of the blended LHT clay slurry were subjected to an oxidative brightening step by treatment with a representative peroxyacid, performic acid (PFA), which was prepared and administered according to Example 2 at various concentrations (200 ppm, 400 ppm, 600 ppm, and 600 ppm, expressed as wet weight of PFA to dry weight of kaolin clay) for a contact time of one hour, during which time the pH was measured. After 1 h, the PFA-treated samples were acidified with sulfuric acid to a pH of 3 and reductively bleached with dithionite at a dosage of 10 lb/ton.

After treatments were complete, all samples were acidified by addition of sulfuric acid to ensure a pH of about 3. This acidification step flocculates the clay so that it can be filtered to remove water. After most of the water was removed during filtration, the resulting filter cakes were transferred to a microwave oven for final drying. Once the moisture was removed down to <0.1%, the samples were pulverized using a micro grinder, pressed into a pellet, and then analyzed to determine GE Brightness of the resulting clay products. Results are listed in Table 3.

TABLE 3
GE Brightness of Purified LHT Clay Samples

| | | | Dithionite, | GE |
|---|---|---|---|---|
| Sample ID | Oxidant, Dosage | pH | lb/ton | Brightness |
| Control 1 | — | — | — | 84.0 |
| (No Treatment) | | | | |
| Control 2 | KMnO₄, 2 lb/ton | — | — | 86.6 |
| (Ozone Equivalent) | | | | |
| Control 3 | KMnO₄, 2 lb/ton | — | — | 85.7 |
| (Ozone Equivalent) | | | | |
| Control 4 | KMnO₄, 2 lb/ton | — | — | 86.7 |
| (Ozone Equivalent) | | | | |
| PFA-200 | PFA, 200 ppm | 6.5 | 10.0 | 83.9 |
| PFA-400 | PFA, 400 ppm | 5.8 | 10.0 | 83.9 |
| PFA-600 | PFA, 600 ppm | 5.1 | 10.0 | 83.9 |
| PFA-800 | PFA, 800 ppm | 4.5 | 10.0 | 84.1 |

Results indicate that oxidative brightening with PFA followed by reductive bleaching had little impact on the brightness of the laboratory-prepared clay. No brightness drop with higher dosages of PFA was observed for these samples. These results suggest that for this particular sample of clay, treatment with dithionite may be marginally productive or counterproductive, which further suggests that purification steps of a given process flow will vary depending on characteristics of the clay to be brightened.

Having described exemplary embodiments of the invention, the invention is further described in the claims which follow.

What is claimed is:

1. A method for oxidative brightening of a mined mineral, wherein the method comprises adding to an aqueous slurry of a mined mineral to be brightened an oxidizing solution comprising a peroxyacid.

2. The method of claim 1, wherein (i) said mined mineral to be brightened is selected from the group comprising kaolin, gypsum, talc, and bentonite, (ii) said peroxyacid is selected from the group consisting of performic acid, peracetic acid, perpropionic acid, peroxymonosulfuric acid (Caro's acid), peroxydisulfuric acid (Marshall's acid), peroxymonophosphoric acid, peroxydiphosphoric acid, or a combination thereof, and (iii) said method further comprises:
(a) optionally adding to said aqueous slurry of a mined mineral to be brightened a bleach-effective quantity of ozone;
(b) after said oxidative brightening step is completed, subjecting the resulting brightened aqueous slurry of a mined mineral to reductive bleaching with a reducing agent, such as sodium dithionite; and
(c) recovering a bleached mineral of increased brightness, improved color, and/or improved purity compared to said mined mineral to be brightened.

3. A bleached mineral obtainable by a method according to claim 1.

4. A method for treating a discolored mined mineral according to claim 1, wherein the method comprises:
(a) combining a carboxylic acid, hydrogen peroxide, an acid catalyst, and water in a chemical mixer to form an oxidative bleach solution and allowing said oxidative bleach solution to reach equilibrium;
(b) allowing the components of said oxidative bleach solution to react until the total amount of peroxyacid in solution is from 8 to 15% by weight;
(c) adding the output of said chemical mixer to an aqueous slurry comprising a discolored mined mineral to be brightened and agitating to form a thoroughly incorporated mixture;
(d) allowing said thoroughly incorporated mixture to react for 10-90 minutes, or from 30 to 60 minutes in an oxidative brightening step;
(e) subjecting the resulting slurry to reductive bleaching with a reducing agent, such as sodium dithionite; and
(f) recovering a bleached mineral of enhanced brightness, improved color, and/or improved purity compared to said discolored mined mineral to be brightened.

5. The method of claim 4, wherein:
(a) said carboxylic acid is selected from the group consisting of formic acid, acetic acid, and propionic acid;
(b) said catalyst is selected from sulfuric acid, hydrochloric acid, or a combination thereof; and
(c) said discolored mined mineral is selected from the group comprising kaolin, gypsum, talc, and bentonite.

6. A bleached mineral obtainable by a method according to claim 4.

7. A method for oxidative brightening of kaolin clay, wherein the method comprises adding to an aqueous slurry of kaolin clay to be brightened an oxidizing equilibrium solution comprising performic acid.

8. The method of claim 7, wherein:
(a) said kaolin clay to be brightened is the result of a mining process;
(b) said kaolin clay to be brightened is selected from the group comprising gray clay and discolored non-gray clay;
(c) said aqueous slurry of kaolin clay to be brightened comprises residual organic polymers, discolored gangue minerals, and/or discolored metals;
(d) the particle size of kaolin clay in said aqueous slurry of kaolin clay to be brightened ranges from about 0.2 to 40 μm;
(e) the concentration of kaolin clay in said aqueous slurry of kaolin clay to be brightened ranges from about 10 to 70% by weight; and/or
(f) the total dry matter content in said aqueous slurry of kaolin clay to be brightened ranges from about 10 to 80% by weight.

9. The method claim 7, wherein said oxidizing equilibrium solution comprising performic acid is an aqueous equilibrium solution prepared by reaction of formic acid and hydrogen peroxide in the presence of an acid catalyst and optionally a stabilizer, wherein:
(a) said formic acid and hydrogen peroxide are combined in a molar ratio of formic acid to hydrogen peroxide ranging from 1:10 to 10:1, from 1:2 to 2:1, preferably 1:1;
(b) said catalyst comprises at least one mineral acid selected from the group comprising sulfuric acid, hydrochloric acid, and a mixture of sulfuric and hydrochloric acids;
(c) said optional stabilizer is selected from the group comprising a phosphonate such as 1-hydroxyethylene-1,1-diphosphonic acid, a pyridinecarboxylic acid such as dipicolinic acid, and a mixture thereof;
(d) said formic acid, hydrogen peroxide, acid catalyst, and optional stabilizer are thoroughly combined in water until an oxidizing equilibrium solution is formed comprising at least formic acid, hydrogen peroxide, and performic acid;
(e) the total amount of performic acid in said oxidizing equilibrium solution is from 8 to 15% by weight; and
(f) the molar ratio of performic acid and formic acid to hydrogen peroxide in said oxidizing equilibrium solution ranges from 1:1 to 3.5:1, preferably from 1.5:1 to 3:1.

10. The method of claim 7, wherein said oxidizing equilibrium solution comprising performic acid is:
(a) continuously prepared in situ in a chemical mixer and then added directly to said aqueous slurry of kaolin clay as an equilibrium solution within a time period ranging from 0.1-2 hours after mixing; or
(b) prepared as a stabilized equilibrium solution and added to said aqueous slurry of kaolin clay after storage.

11. The method of claim 7, wherein said oxidizing equilibrium solution comprising performic acid is added to said aqueous slurry comprising kaolin clay and the resulting slurry is agitated to form a thoroughly incorporated mixture wherein:
(a) the total performic acid in said thoroughly incorporated mixture ranges from 10 ppm to 3000 ppm, wherein ppm is defined as wet weight of performic acid (e.g., milligrams of performic acid indicated as a 100% performic acid) to dry weight of kaolin clay (e.g., kilogram of dry kaolin clay);
(b) the pH of said thoroughly incorporated mixture ranges from 2.0 to 8.5, or from 3.0 to 7.0; and
(c) the contact time between performic acid and kaolin clay to be brightened in said thoroughly incorporated mixture ranges from 10 min to 90 min, or from 30 to 60 minutes.

12. The method of claim 7, wherein said oxidative brightening is effected during beneficiation of an aqueous slurry of kaolin clay to be brightened and said method further comprises:
(a) optionally subjecting said aqueous slurry of kaolin clay to be brightened to a bleach-effective quantity of ozone;
(b) subjecting said aqueous slurry of kaolin clay to be brightened to one or more additional beneficiation steps selected from the group comprising selective flocculation, selective solid/solid separation, magnetic separation, media grinding, flotation, centrifugation, thickening, and combinations thereof, wherein said additional beneficiation steps are effected prior to or after said oxidative brightening step is completed;
(c) subjecting said aqueous slurry of kaolin clay to be brightened to reductive bleaching with a reducing agent selected from the group comprising dithionite, bisulfite, borohydride, aluminum hydride, and salts thereof, wherein said reductive bleaching step is effected after said oxidative brightening and said additional beneficiation steps are completed;
(d) acidification of said aqueous slurry of kaolin clay to a pH ranging from 2.5 to 4.5, dewatering, and drying, wherein said acidification, dewatering, and drying steps are effected after the step of reductive bleaching is completed; and
(e) recovering bleached kaolin clay of increased brightness, improved color, and/or improved purity compared to the kaolin clay to be brightened.

13. The method of claim 7, wherein the method results in
(i) degradation and removal of residual organic polymers,
(ii) removal of discolored gangue minerals, and/or
(iii) removal of discolored metals from said kaolin clay to be brightened.

14. A bleached kaolin clay obtainable by a method according to claim 7.

15. A composition comprising an aqueous slurry of kaolin clay, optionally the result of a mining process, and an amount of an oxidizing solution comprising performic acid effective to brighten the kaolin clay.
